(19) United States
(12) Patent Application Publication
(10) Pub. No.: US 2008/0167211 A1
(43) Pub. Date: Jul. 10, 2008

(54) Hypochlorite Daily Shower Cleaner

(76) Inventors: Nicholas L. Pivonka, Dublin, CA (US); Michael Robbins, Marietta, GA (US); William L. Smith, Pleasanton, CA (US)

Correspondence Address: THE CLOROX COMPANY, P.O. BOX 24305, OAKLAND, CA, 94623-1305, US

(21) Appl. No.: 11/619,844

(22) Filed: Jan. 4, 2007

(51) Int. Cl. C11D 3/395

(52) U.S. Cl. 510/199

(57) ABSTRACT

This invention relates to compositions and methods for treating surfaces, especially shower surfaces, with dilute hypochlorite and hypochlorous acid compositions. The compositions have between 100 and 900 ppm available chlorine. These compositions can contain surfactants, especially betaine or sulfobetaine surfactants, and hydrotropes.

### BACKGROUND OF THE INVENTION

1. Field of the Invention

This invention relates to compositions and methods of use for dilute hypohalous acid and hypohalous acid salt for cleaning showers and other surfaces. The resulting compositions have high pH and less than 0.1% hypochlorite and yet are useful for controlling mold and disinfecting surfaces.

2. Description of the Related Art

U.S. Pat. No. 6,936,220 to Hoshino et al. discloses applying a mist of dilute chlorine-containing oxidizing agent to a variety of surfaces. U.S. Pat. No. 5,348,682 to Finley et al. discloses a thickened composition containing 0.4 to 1.2% available chlorine for treating shower walls. U.S. Pat. No. 5,236,614 to Jacquet et al. discloses compositions containing 1.5 to 4% hypochlorite for treating a variety of surfaces. U.S. Pat. App. 2005/0124519 to Sherry et al. discloses wipes with a cleaning paste containing a hypochlorite source for cleaning bathroom surfaces. U.S. Pat. No. 6,482,791 to Sano et al. discloses a cleaner containing 0.1 to 7% hypochlorite. U.S. Pat. No. 6,200,941 to Strandburg et al. discloses bathroom cleaners containing at least 0.5% hypochlorite. U.S. Pat. No. 6,245,361 to Merritt discloses a disinfectant composition containing at least 1100 ppm available chlorine and 600 to 800 ppm quat. These compositions are useful but they leave residual quat on the cleaning surface, which can be irritating. U.S. Pat. No. 6,036,789 to Weibel discloses bathroom cleaners containing 1 to 4% hypochlorite.

Chlorine bleaches such as aqueous sodium hypochlorite have long been recognized as being effective against all types of micro-organisms provided that the bleach is used in sufficiently high concentrations such as 5,000 ppm (0.5%) of active sodium hypochlorite and higher depending on the micro-organism to be eliminated. These types of solutions are recommended for use for disinfecting an area where blood or other potentially pathogenic biological contaminants have been spilled or released and total disinfection is required. In concentrations exceeding 1000 ppm, the hypochlorite causes decoloration or discoloration of colored or patterned clothing, bedding, curtains, etc.; deterioration or damage of metal, plastics, wood, etc., and, in some cases, has a question as to safety when sprayed, having a possibility of irritating the eye mucosa. Hypochlorite is ideal as a disinfectant, since after use residual hypochlorite is converted to salt and other innocuous agents. At such high levels of sodium hypochlorite, the chlorine smell from the bleach simply makes this agent undesirable for routine cleaning and disinfection of showers and other household uses where the bleach solution is atomized into the air. At lower levels of sodium hypochlorite the composition may not be effective at disinfecting unless the pH is lowered to near neutral to shift the equilibrium of sodium hypochlorite to hypochlorous acid, which is a stronger disinfectant. However, this lower pH composition also can give off a higher level of chlorine smell from bleach and the increased reactivity of hypochlorous acid can prevent the incorporation of surfactants that are traditionally stable in hypochlorite compositions at basic pH.

To minimize expense, undesirable odors and possible detrimental effects of disinfecting agents on surfaces to be disinfected, it is desirable to minimize the amount of disinfecting agents used while still retaining efficacy against pathogenic micro-organisms. Based on the prior art examples, the need exists for compositions of hypochlorite that contain surfactants, that act as disinfectants, that leave no residual disinfectant, and have low chlorine odor.

### SUMMARY OF THE INVENTION

In accordance with the above objects and those that will be mentioned and will become apparent below, one aspect of the present invention is a composition comprising 100 ppm to 900 ppm hypohalous acid and hypohalous acid salt as available chlorine; and 0.001% to 0.1% by weight of a surfactant; wherein the composition has a pH of greater than pH 10.

In accordance with the above objects and those that will be mentioned and will become apparent below, another aspect of the present invention is a composition comprising 100 ppm to 900 ppm hypohalous acid and hypohalous acid salt as available chlorine; 0.001% to 0.05% by weight of an amphoteric surfactant; and 0.001% to 0.1% by weight of a hydrotrope; wherein the composition has a pH of greater than pH 10.

In accordance with the above objects and those that will be mentioned and will become apparent below, another aspect of the present invention is a method of treating mold comprising applying to shower walls a composition comprising 100 ppm to 900 ppm hypohalous acid and hypohalous acid salt as available chlorine, wherein the composition has a pH of greater than pH 10.

Further features and advantages of the present invention will become apparent to those of ordinary skill in the art in view of the detailed description of preferred embodiments below.

### DETAILED DESCRIPTION

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentage (“%'s”) are in weight percent (based on 100% active) of the cleaning composition alone.

The term “surfactant”, as used herein, is meant to mean and include a substance or compound that reduces surface tension when dissolved in water or water solutions, or that reduces interfacial tension between two liquids, or between a liquid and a solid. The term “surfactant” thus includes anionic, nonionic, cationic and/or amphoteric agents.

As used herein, the term “microbiological contaminants” refers to any microbial contaminant. Examples of microbiological contaminants include, but are not limited to, allergens, fungi, bacteria, viruses, protozoa, and molds, including mold spores. Examples of such microbiological contaminants include Stachybotrys Chartarum, Aspergillus niger, Absidia sp., Acrodorticm salmoneum, Aspergillus candies, anthrax, etc.

The term “surface” refers to hard and soft surfaces and includes, but are not limited to, shower walls, shower curtains, tile grout, plaster, drywall, ceramic, cement, clay, bricks, stucco, plastic, wallpaper, fabric, tiles, cement, and vinyl flooring, heating and/or cooling fins, filters, vanes, baffles, vents, crevices in walls or ceilings, paper and wood products such as lumber, paper, and cardboard, woven products such as blankets, clothing, carpets, drapery and the like.

### Hypohalous Acid and Salts

Suitable hypohalous acids and salts may be provided by a variety of sources, including compositions that lead to the formation of positive halide ions and/or hypohalite ions; hypohalous acid, hypohalous acid salt, hypohalous acid generating species, hypohalous acid salt generating species; as well as compositions that are organic based sources of halides, such as chloroisocyanurates, haloamines, haloimines, haloimides and haloamides, or mixtures thereof. These compositions may also produce hypohalous acid or hypohalite species in situ. Suitable hypohalous acids and salts for use herein include the alkali metal and alkaline earth metal hypochlorites, hypobromites, hypoiodites, chlorinated trisodium phosphate dodecahydrates, potassium and sodium dichloroisocyanurates, potassium and sodium trichlorocyanurates, N-chloroimides, N-chloroamides, N-chlorosulfamide, N-chloroamines, chlorohydantoins such as dichlorodimethyl hydantoin and chlorobromo dimethylhydantoin, bromo-compounds corresponding to the chloro-compounds above, and compositions which generate the corresponding hypohalous acids, or mixtures thereof.

In one embodiment wherein the compositions herein are liquid, said hypohalite composition comprises an alkali metal and/or alkaline earth metal hypochlorite, or mixtures thereof. Compositions may comprise an alkali metal and/or alkaline earth metal hypochlorite selected from the group consisting of sodium hypochlorite, potassium hypochlorite, magnesium hypochlorite, lithium hypochlorite and calcium hypochlorite, and mixtures thereof.

The hypohalous acids and salt composition may be an equilibrium mixture of hypochlorous acid and hypochlorite salt, for example, sodium hypochlorite. The active species is present in an amount as available chlorine from about 0.01 weight percent (100 ppm) to about 0.09 weight percent (900 ppm) of the composition, or from about 0.03 (300 ppm) to about 0.09 weight percent (900 ppm) of the composition, or from about 0.03 (300 ppm) to about 0.08 weight percent (800 ppm) of the composition, or from about 0.03 (300 ppm) to about 0.06 weight percent (600 ppm) of the composition.

The amount of available halogen oxidant in the composition is determined by placing samples of the composition into about 50 milliliters of distilled water, followed by addition of about 10 milliliters of a 10 weight/weight percent solution of potassium iodide and addition of about 10 milliliters of a 10 volume percent solution of sulfuric acid, the resulting mixture being well stirred. The resulting yellow to brown solution, whose color is the result of oxidation of free iodine ion (I⁻) to molecular iodine (I₂), was then volumetrically titrated to an essentially colorless endpoint by addition of standardized 0.1 Molar sodium thiosulfate (Na₂S₂O₃) titrant. Calculation then expresses the result as percent of available molecular chlorine (Cl₂), that is to say assigning two equivalents per mole of titrated hypohalite oxidant. Stability results are then expressed by repeated assays over time using identically prepared samples resulting from the same composition, normalized to 100 percent representative of the starting available chlorine measured initially.

The hypohalous acid and hypohalous acid salt can be formed from the neutralization of chlorine gas with caustic solution, during which an equimolar amount of halide is also formed. In electrolysis, halide is consumed and none is formed. Dilute hypohalous acid and salt technology is described in U.S. Pat. App. 2005/0214,386, U.S. Pat. App. 2005/0216291, U.S. Pat. App. 2005/0232847, U.S. Pat. App. 2005/0232848, U.S. Pat. App. 2005/0221113, and U.S. Pat. App. 2005/0233900, all of which are incorporated by reference herein.

### Surfactants

Where present the surfactant may be selected from anionic, nonionic, cationic, zwitterionic, amphoteric and mixtures thereof. In one embodiment of the present invention the surfactant is selected from amphoteric, zwitterionic and mixtures thereof. In another embodiment of the present invention, the surfactant is selected from amine oxide, betaine, sulphobetaine and mixtures thereof. The surfactant is added at levels of generally about 0.001 to 0.1% weight of the surfactant, or 0.001 to 0.08% weight of the surfactant, or 0.001 to 0.05% weight of the surfactant, or less than 0.1%, or less than 0.8%, or less than 0.05% surfactant.

Suitable anionic surfactants for use herein include alkyl sulphates, alkoxylated sulphate surfactants, alkyl aryl sulphates, alkyl sulphonates, alkoxylated sulphonate surfactants. Examples of suitable sulphate surfactants include sodium dodecyl sulphate, sodium tetradecyl sulphate, sodium hexadecyl sulphate. Alkyl ethoxylated sulphates, alkyl butoxylated sulphates as well as alkyl propoxylated sulphates are contemplated herein. Suitable anionic surfactants for use herein further include C6-C20 alkyl alkoxylated linear or branched diphenyl oxide disulphonate surfactants. Other suitable anionic surfactants for use herein include alkylcarboxylates. Other anionic surfactants can include salts (including, for example, sodium, potassium, ammonium, and substituted ammonium salts such as mono-, di- and triethanolamine salts) of soap, C8-C24 olefinsulfonates, sulfonated polycarboxylic acids, acyl glycerol sulfonates, fatty oleyl glycerol sulfates, alkyl phenol ethylene oxide ether sulfates, alkyl phosphates, isethionates such as the acyl isethionates, N-acyl taurates, alkyl succinamates and sulfosuccinates, monoesters of sulfosuccinate, diesters of sulfosuccinate, acyl sarcosinates, sulfates of alkyl polysaccharides such as the sulfates of alkylpolyglucoside, branched primary alkyl sulfates, and alkyl polyethoxy carboxylates.

Suitable amphoteric surfactants for use herein include amine oxides having the following formula R₁R₂R₃NO wherein each of R₁, R₂ and R₃ is independently a saturated substituted or unsubstituted, linear or branched hydrocarbon chains of from 1 to 30 carbon atoms. Such amine oxides are commercially available from Hoechst and Clariant.

Suitable zwitterionic surfactants for use herein contain both cationic and anionic hydrophilic groups on the same molecule at a relatively wide range of pH's. The typical cationic group is a quaternary ammonium group, although other positively charged groups like phosphonium, imidazolium and sulfonium groups can be used. The typical anionic hydrophilic groups are carboxylates and sulfonates, although other groups like sulfates, phosphonates, and the like can be used. A generic formula for some zwitterionic surfactants to be used herein is R₁—N⁺(R₂)(R₃)R₄X⁻ wherein R₁ is a hydrophobic group; R₂ and R₃ are each C₁-C₄ alkyl, hydroxy alkyl or other substituted alkyl group which can also be joined to form ring structures with the N; R₄ is a moiety joining the cationic nitrogen atom to the hydrophilic group and is typically an alkylene, hydroxy alkylene, or polyalkoxy group containing from 1 to 10 carbon atoms; and X is the hydrophilic group which is preferably a carboxylate or sulfonate group. Suitable hydrophobic groups R₁ are alkyl groups containing from 1 to 24, preferably from 12 to 18, more preferably 14 to 16 carbon atoms. The hydrophobic group can contain unsaturation and/or substituents and/or linking groups such as aryl groups, amido groups, ester groups and the like. In general, the simple alkyl groups are suitable for cost and stability reasons. Suitable zwitterionic surfactants include betaine and sulphobetaine surfactants, functionalized betaines such as acyl betaines, alkylamidoalkyldimethyl betaines, alkyl imidazoline alanine betaines, glycine betaines, derivatives thereof and mixtures thereof. Suitable betaine and sulphobetaine surfactants for use herein are the betaine/sulphobetaine and betaine-like detergents wherein the molecule contains both basic and acidic groups which form an inner salt giving the molecule both cationic and anionic hydrophilic groups over a broad range of pH values. Some common examples of these detergents are described in U.S. Pat. Nos. 2,082,275, 2,702,279, 2,255,082, and 5,252,245 incorporated herein by reference. Suitable betaine and sulphobetaine surfactants herein are according to the formula R₂R₁—N⁺—(CH₂)ₙ—Y—R₃ wherein R₁ is a hydrocarbon chain containing from 1 to 24 carbon atoms, preferably from 12 to 18, more preferably from 14 to 16, wherein R₂ and R₃ are hydrocarbon chains containing from 1 to 3 carbon atoms, suitably 1 carbon atom, wherein n is an integer from 1 to 10, suitably from 1 to 6, suitably is 1, Y is selected from the group consisting of carboxyl and sulfonyl radicals and wherein the sum of R₁, R₂ and R₃ hydrocarbon chains is from 14 to 24 carbon atoms, or mixtures thereof. Examples of suitable betaine surfactants include C12-C18 alkyl dimethyl betaine such as coconut-betaine and C10-C16 alkyl dimethyl betaine such as laurylbetaine. A surfactant of this type is a C10-C14 fatty acylamidopropylene-(hydroxypropylene) sulfobetaine that is available from the Sherex Company under the trade name “Varion CAS sulfobetaine”. Suitable betaines include the C₁₄₋₁₈ alkyl betaines and C₁₄₋₁₈ alkyl sulfobetaines. Especially preferred is a cetyl dimethyl betaine (CEDB) such as Amphosol CDB (a trademarked product of the Stepan Company), which is about 95% or greater C₁₆, less than 5% C_{12/14} and less than 1% C₁₈. It is noted that when referring to carbon chain lengths of the betaine or any other compound herein, the commercial, polydisperse forms are contemplated (but not required). Thus, a given chain length within the preferred C₁₄₋₁₈ range will be predominately, but not exclusively, the specified length. As used herein in reference to the betaine or sulfobetaine, the term “alkyl” includes both saturated and unsaturated groups. Fully saturated alkyl groups are preferred in the presence of hypochlorite. C₁₀₋₁₈ alkylamido and alkylamino betaines, and sulfobetaines having C₁₄₋₁₈ alkyl, or C₁₀₋₁₈ alkylamino or alkylamido groups, are also suitable for use in the compositions of the present invention.

A suitable composition contains a binary surfactant comprising a betaine or other amphoteric or zwitterionic surfactant and anionic counterion. Examples of other suitable surfactants include amine oxides, sarcosinates, taurates and quaternary ammonium compounds. The amphoteric or zwitterionic surfactant is added at levels of generally about 0.001 to 0.1% weight of the amphoteric, or 0.001 to 0.08% weight of the amphoteric, or 0.001 to 0.05% weight of the amphoteric, or less than 0.1%, or less than 0.8%, or less than 0.05% amphoteric surfactant.

The counterion is an anionic organic counterion selected from the group consisting of C₂₋₆ alkyl carboxylates, aryl carboxylates, C₂₋₁₀ alkyl sulfonates, aryl sulfonates, sulfated C₂₋₁₀ alkyl alcohols, sulfated aryl alcohols, and mixtures thereof. The aryl compounds are derived from benzene or napthalene and may be substituted or not. The alkyls may be branched or straight chain, and preferred are those having two to eight carbon atoms. The counterions may be added in acid form and converted to the anionic form in situ, or may be added in anionic form. Suitable substituents for the alkyls or aryls are C₁₋₄ alkyl or alkoxy groups, halogens, nitro groups, and mixtures thereof. Some carboxylic acid cleaning actives may be present in both the acid and conjugate base forms, the latter which could serve as the counterion. The C₂₋₆ alkyl carboxylates may act in this manner. Where the counterion is not sufficiently surface active, it acts as a hydrotrope. The hydrotropes are suitably selected from short chain alkylarylsulfonates, salts of benzoic acid, benzoic acid derivatives (such as chlorobenzoic acid), and mixtures thereof. As used herein, aryl includes, without limitation, at least benzene, naphthalene, xylene, cumene and similar aromatic nuclei. These aryl groups can be substituted with one or more substituents known to those skilled in the art, e.g., halo (chloro, bromo, iodo, fluoro), nitro, or C1-4 alkyl or alkoxy. Suitable is sodium xylene sulfonate (such as Stepanate SXS, available from Stepan Company).

The organic counterion or hydrotrope is added at levels of generally about 0.001 to 0.1% weight, or 0.001 to 0.08% weight, or 0.001 to 0.05% weight, or less than 0.1%, or less than 0.8%, or less than 0.05%. A preferred mole ratio of zwitterionic or amphoteric to counterion depends on the chain length and concentration of the zwitterionic or amphoteric, type of counterion, and the ionic strength of the solution, as well as whether the primary object of the composition is phase stability or viscosity. A suitable mole ratio is about 10:1 to 1:3, or about 2:1 to 1:2.

### Buffers

The composition of the invention may contain a builder or buffer. The builder or buffer should be stable to hypohalous acid or hypohalous acid salt if long term storage is desired. If the solutions of the composition are generated prior to use, then builders or buffers having less stability may be used.

The composition may include a builder or buffer, which can be used as a pH adjusting agent or as a sequestering agent in the composition. A variety of builders or buffers can be used and they include, but are not limited to, phosphate-silicate compounds, carbon dioxide or carbonate, zeolites, alkali metal, ammonium and substituted ammonium polyacetates, trialkali salts of nitrilotriacetic acid, carboxylates, polycarboxylates, carbonates, bicarbonates, polyphosphates, aminopolycarboxylates, polyhydroxysulfonates, and starch derivatives.

Builders or buffers can also include polyacetates and polycarboxylates. The polyacetate and polycarboxylate compounds include, but are not limited to, sodium, potassium, lithium, ammonium, and substituted ammonium salts of ethylenediamine tetraacetic acid, ethylenediamine triacetic acid, ethylenediamine tetrapropionic acid, diethylenetriamine pentaacetic acid, nitrilotriacetic acid, oxydisuccinic acid, iminodisuccinic acid, mellitic acid, polyacrylic acid or polymethacrylic acid and copolymers, benzene polycarboxylic acids, gluconic acid, sulfamic acid, oxalic acid, phosphoric acid, phosphonic acid, organic phosphonic acids, acetic acid, and citric acid. These builders or buffers can also exist either partially or totally in the hydrogen ion form.

The builder agent can include sodium and/or potassium salts of EDTA and substituted ammonium salts. The substituted ammonium salts include, but are not limited to, ammonium salts of methylamine, dimethylamine, butylamine, butylenediamine, propylamine, triethylamine, trimethylamine, monoethanolamine, diethanolamine, triethanolamine, isopropanolamine, ethylenediamine tetraacetic acid and propanolamine.

Buffering and pH adjusting agents, when used, include, but are not limited to, organic acids, mineral acids, alkali metal and alkaline earth salts of silicate, metasilicate, polysilicate, borate, hydroxide, carbonate, carbamate, phosphate, polyphosphate, pyrophosphates, triphosphates, tetraphosphates, ammonia, hydroxide, monoethanol-amine, monopropanolamine, diethanolamine, dipropanolamine, triethanolamine, and 2-amino-2methylpropanol. Preferred buffering agents for compositions of this invention are nitrogen-containing materials. Some examples are amino acids such as lysine or lower alcohol amines like mono-, di-, and tri-ethanolamine. Other preferred nitrogen-containing buffering agents are tri(hydroxymethyl) amino methane (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine). Other suitable buffers include ammonium carbamate, citric acid, acetic acid. Mixtures of any of the above are also acceptable. Useful inorganic buffers/alkalinity sources include ammonia, the alkali metal carbonates and alkali metal phosphates, e.g., sodium carbonate, sodium polyphosphate. For additional buffers see WO 95/07971, which is incorporated herein by reference. Other builders or pH adjusting agents include sodium or potassium hydroxide.

When employed, the builder or buffer comprises at least about 0.001%, or about 0.01-0.1% of the cleaning composition, or about 0.01-0.5% of the cleaning composition.

### Fragrance

The composition of the invention may contain fragrance. The fragrance should be stable to hypohalous acid or hypohalous acid salt if long term storage is desired. If the solutions of the composition are generated prior to use, then fragrances having less stability may be used. Compositions of the present invention may comprise from about 0.0001% to about 0.1% by weight of the fragrance.

### Thickener

The compositions can contain inorganic thickening agents. The inorganic thickener can be any natural or synthetic clays, aluminas, etc. One suitable class of thickeners include colloid-forming clays, for example, such as smectite and/or attapulgite types. The smecties are a family of water swellable clays having a lattice sheet structure. Smectite clays are more commonly known as bentonite or magnesium aluminium silicate. Once hydrated, most smectites form an alkaline dispersion. Water washed smectite clays are often preferred because they are controlled for purity, bacteria, whiteness, heavy metals and performance efficiency. The smectites produce thixotropic, pseudoplastic dispersions with yield value. These clays are available in a range of viscosities, although their primary functions is to impart yield value and thereby stabilize emulsions, suspension, and foams. They are often used in combination with anionic and nonionic organic thickeners to finely tailor rheology and for advantages synergism in viscosity and/or yield value. The hormites are water dispersible clays with a chain structure that results in microscopic, needle-like particles. The commercial varieties are palygorskite, more commonly known as attapulgite, and sepiolite. The primary commercial palygorskite, attapulgite has typically short (less than 2 um) and low aspect ratio (less than 10:1) needles. When hormite clays are dispersed in water, they do not swell like smectites, but deagglomerate in proportion to the amount of shear applied, and form a random colloidal network. This loosely cohesive structure offers rheological properties similar to those of smectite clays but often with somewhat less physical stability.

Laponite® clay shear thins. The shear thinning behavior is suitable for dispensing through a spray applicator that may be trigger or pump activated or an aerosol. It then rethickens on the surface.

The clay materials can be described as expandable layered clays, i.e., aluminosilicates and magnesium silicates. The term “expandable” as used to describe the instant clays relates to the ability of the layered clay structure to be swollen, or expanded, on contact with water. The expandable clays used herein are those materials classified geologically as smectites (or montmorillonite) and attapulgites (or polygorskites). Smectites are three-layered clays. There are two distinct classes of smectite-type clays. In the first, aluminum oxide is present in the silicate crystal lattice; in the second class of smectites, magnesium oxide is present in the silicate crystal lattice. The general formulas of these smectites are Al₂(Si₂O₅)₂(OH)₂ and Mg₃(Si₂O₅)(OH)₂, for the aluminum and magnesium oxide type clays, respectively. It is to be recognized that the range of the water of hydration in the above formulas may vary with the processing to which the clay has been subjected.

Commercially available clays include, for example, montmorillonite (bentonite), volchonskoite, nontronite, beidellite, hectorite, saponite, sauconite and vermiculite. The clays herein are available under various trade names such as Gelwhite H NF® and Gelwhite GP® from Southern Clay Products. (both montmorillonites); Van Gel O® from R. T. Vanderbilt, smectites, laponites and layered silicates from Southern Clay Products. A second type of expandable clay material useful in the instant invention is classified geologically as attapulgite (polygorskite). Attapulgites are magnesium-rich clays having principles of superposition of tetrahedral and octahedral unit cell elements different from the smectites. Like the smectites, attapulgite clays are commercially available. For example, such clays are marketed under the tradename Attagel®, i.e. Attagel 40®, Attagel 50® and Attagel 150® from Engelhard Minerals & Chemicals Corporation.

One such synthetic mineral is sodium lithium magnesium silicate (CAS Reg. No. 53320-86-8) and in the Cosmetic, Toiletries and Fragrance Association (CTFA) dictionary as Sodium Magnesium Silicate. This synthetic mineral is sold commercially under the trade name Laponite®, a registered trademark of Southern Clay Products, Inc., Gonzales, Tex.

The thickener may form a solution, a flowable gel or a rigid gel. The thickener component may be used in amounts of about 0.001% to 1% by weight.

### Additional Ingredients

The compositions may also include minor amounts, generally not more than at total of 1% wt., desirably less than 0.1% wt. of one or more optional constituents including ones which may improve the aesthetic appeal of the compositions, viz., perfumes and colorants. These optional ingredients may be present in larger amounts if they are kept physically separated from the hypohalous acid composition during long-term storage. Such optional constituents should not undesirably affect the shelf stability or rheology of the compositions. By way of non-limiting example such further constituents include one or more coloring agents, fragrances and fragrance solubilizers, viscosity modifying agents, other surfactants, pH adjusting agents and pH buffers including organic and inorganic salts, optical brighteners, opacifying agents, hydrotropes, antifoaming agents, anti-spotting agents, preservatives, and anti-corrosion agents. The compositions may also include surface active polymers and nanoparticles as disclosed in PCT App. WO2004/037944 to Valpey et al. The use and selection of these optional constituents is well known to those of ordinary skill in the art.

Where the composition is used to treat mold or other microbiological contaminants, the addition of other agents that have short-term or long-term effectiveness against these contaminants may be included. For example, octaborate is known to be effective against the reoccurrence of mold and mildew.

### Water and pH

The water should be present at a level of less than about 99.999%. The water may be deionized, filtered to remove impurities including metals and organic carbon, purified by reverse osmosis, purified by distillation, or any combination thereof. Purified water may be prepared by a process selected from the group consisting of sodium cation exchange, hydrogen cation exchange, reverse osmosis, activated carbon treatment, UV light treatment, UVC, ozone treatment, chlorination, ultrafiltration, nanofiltration, electrodialysis, and a combination thereof. During preparation there may be a need for hygiene and segregation to prevent the introduction of compounds that are oxidized by hypochlorite since these become more important at low concentrations where the loss of a few ppm may be significant.

The composition may be adjusted for pH using a pH adjusting agent. Suitable pH adjusting agents include carbon dioxide, alkali metal carbonate, alkali metal bicarbonate, alkali metal silicates, alkali metal hydroxide, alkali phosphate salt, alkaline earth phosphate salt, alkali borate salt, hydrochloric acid, nitric acid, sulfuric acid, alkali metal hydrogen sulfate, acetic acid, vinegar from various sources, other carboxylic acids, polycarboxylates, organic sulfonic acids, sulfamic acid, amine, alkyl amine, dialkyl amine, and trialkyl amine. The composition may have a pH from 10 to 13, or 10 to 12, or 11 to 12, or greater than 10, or greater than 11.

### Use and Delivery

The compositions can be used to treat, prevent or control mold and mildew, for example by applying to shower walls or other bathroom surfaces. The compositions of the invention can be delivered via bottle, spray, aerosol, or a directed flow such as the bleach pen as in U.S. Pat. No. 6,905,276. The compositions of the invention can be delivery via devices described in U.S. Pat. App. 2005/0221113 and U.S. Pat. App. 2005/0232848. The compositions of the invention can be delivered as part of a multi-compartment delivery system, for example as described in U.S. Pat. No. 5,954,213, U.S. Pat. No. 5,316,159, WO2004/014760, U.S. Pat. No. 6,610,254, and U.S. Pat. No. 6,550,694. The compositions of the invention can be delivered by an automatic or semi-automatic device as part of an automated shower cleaning apparatus, for example as disclosed in U.S. Pat. No. 6,820,821 to Linstedt et al. and PCT App. WO03/099452 to Mazooji et al.

### EXAMPLES

The concentration of hypochlorite and pH of compositions was tracked for 28 days in a prototype composition containing approximately 500 ppm hypochlorite, 0.05% lauramine oxide, 0.015% by weight sodium hydroxide, and optionally 0.002% by weight fragrance. The product was tracked with and without the addition of a fragrance in polyethylene terephthalate (PET) and the results for storage at 120° F. are given in Table 1.

TABLE I

| | | | pH after 28 | % Remaining |
|---|---|---|---|---|
| | Initial pH | Initial Conc. | days | After 28 days |
| No additives | 11.48 | 520 ppm | 11.30 | 99% |
| HDPE | | | | |
| Unfragranced | 11.54 | 521 ppm | 11.30 | 89% |
| PET | | | | |
| Fragranced | 11.48 | 524 ppm | 11.21 | 85% |
| PET | | | | |

Compositions at lower hypochlorite levels and neutral or acidic pH are not effective at decolorizing mold and mildew. Compositions at higher hypochlorite levels have an irritating odor and are not stable in PET containers.

Additional stability studies are summarized in Table II. Both Lauramine oxide and Cetyl betaine with SXS gave good stability after 28 days at 120° F. in HDPE bottles.

TABLE II

| | 1 | 2 | 3 | 4 | 5 | 6 | 7 | 8 | 9 | 10 |
|---|---|---|---|---|---|---|---|---|---|---|
| Amine | 0.01 | 0.01 | 0.01 | 0.01 | 0.01 | 0.01 | | | | |
| Oxide | | | | | | | | | | |
| Cetyl | | | | | | | 0.04 | 0.04 | 0.04 | 0.04 |
| Betaine | | | | | | | | | | |
| SXS | | | | | | | 0.028 | 0.028 | 0.028 | 0.028 |
| NaOH | 0.02 | 0.02 | 0.04 | 0.04 | | | 0.04 | 0.04 | | |
| Na₂CO₃ | | | | | 0.1 | 0.1 | | | 0.1 | 0.1 |
| pH | 11.9 | 11.9 | 12.0 | 12.1 | 11.0 | 11.0 | 12.2 | 12.2 | 11.1 | 11.1 |
| Initial | 360 | 658 | 337 | 665 | 339 | 630 | 316 | 637 | 325 | 660 |
| NaOCl | | | | | | | | | | |
| Stability | 90% | 98% | 94% | 96% | 95% | 96% | 55% | 79% | 48% | 59% |

Compositions were tested for their effectiveness against Staph organisms in Tables III and IV. Compositions containing betaine and xylene sulfonate as a hydrotrope were effective.

TABLE III

| | A | B | C | D | E | F |
|---|---|---|---|---|---|---|
| NaOCl | 0.034 | 0.068 | 0.034 | 0.069 | 0.035 | 0.071 |
| Amine | 0.01 | 0.01 | 0.01 | 0.01 | 0.01 | 0.01 |
| Oxide | | | | | | |
| Na | | | | | 0.1 | 0.1 |
| Carbonate | | | | | | |
| NaOH | 0.1 | 0.1 | 0.1 | 0.1 | | |
| pH | 11.9 | 11.85 | 12.25 | 12.22 | 11.08 | 11.01 |
| Effective | No | No | No | No | No | No |

TABLE IV

| | G | H | I | J | Comparative |
|---|---|---|---|---|---|
| NaOCl | 0.034 | 0.068 | 0.034 | 0.070 | 0.02 |
| Betaine | 0.04 | 0.04 | 0.04 | 0.04 | |
| Hydrotrope | 0.028 | 0.028 | 0.028 | 0.028 | |
| Na | | | 0.1 | 0.1 | |
| Carbonate | | | | | |
| NaOH | 0.04 | 0.04 | | | |
| pH | 12.3 | 12.2 | 11.1 | 11.0 | 7 |
| Effective | Yes | Yes | No | Yes | No |

While various patents have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

We claim:

1. An aqueous composition comprising:
a. 100 ppm to 900 ppm available chlorine from hypohalous acid and hypohalous acid salt; and
b. 0.001% to 0.1% by weight of a surfactant;
a. wherein the composition has a pH of greater than pH 10.

2. The composition of claim 1, wherein the composition comprises 0.001% to 0.08% surfactant.

3. The composition of claim 1, wherein the surfactant comprises a surfactant selected from the group consisting of betaines, sulfobetaines and combinations thereof.

4. The composition of claim 1, wherein the surfactant comprises an amine oxide.

5. The composition of claim 1, wherein the composition additionally comprises a hydrotrope.

6. The composition of claim 5, wherein the composition comprises less than 0.08% hydrotrope.

7. The composition of claim 5, wherein the hydrotrope comprises an aromatic sulfonate.

8. The composition of claim 1, wherein the composition additionally comprises a buffer.

9. The composition of claim 8, wherein the buffer comprises silicate.

10. An aqueous composition comprising:
a. 100 ppm to 900 ppm available chlorine from hypohalous acid and hypohalous acid salt;
b. 0.001% to 0.05% by weight of a zwitterionic surfactant; and
c. 0.001% to 0.1% by weight of a hydrotrope;
d. wherein the composition has a pH of greater than pH 10.

11. The composition of claim 10, wherein the surfactant comprises a surfactant selected from the group consisting of betaines, sulfobetaines and combinations thereof.

12. The composition of claim 10, wherein the composition comprises 300 ppm to 600 ppm hypohalous acid and hypohalous acid salt as available chlorine.

13. The composition of claim 10, wherein the composition comprises less than 0.08% hydrotrope.

14. The composition of claim 13, wherein the hydrotrope comprises an aromatic sulfonate.

15. The composition of claim 10, wherein the composition has a pH of greater than pH 11.

16. The composition of claim 10, wherein the composition additionally comprises a buffer.

17. The composition of claim 16, wherein the buffer comprises silicate.

18. A method of treating mold comprising:
a. applying to shower walls an aqueous composition comprising 100 ppm to 900 ppm available chlorine from hypohalous acid and hypohalous acid salt, wherein the composition has a pH of greater than pH 10.

19. The method of claim 18, additionally comprising 0.001% to 0.1% by weight of surfactant.

20. The method of claim 18, wherein the composition is supplied by an automatic or semi-automatic device.
